(19) United States
(12) Patent Application Publication
(10) Pub. No.: US 2026/0161937 A1
(43) Pub. Date: Jun. 11, 2026

(54) PERSONALIZED GENERATIVE MODEL INTERACTIONS

(71) Applicant: GOOGLE LLC, Mountain View, CA (US)

(72) Inventor: Agoston Weisz, Zurich (CH)

(21) Appl. No.: 18/977,203

(22) Filed: Dec. 11, 2024

(51) Int. Cl. G06N 3/08; G06F 40/35

(52) U.S. Cl. CPC G06N 3/08; G06F 40/35

(57) ABSTRACT

Implementations described herein are directed to learning interaction style(s) of a user with a generative model (GM) based on prior interaction(s) between the user and the GM, and utilizing the interaction style(s) in generating responsive content during subsequent interaction(s). For example, processor(s) of a system can receive user input; process, using GM and based on a particular interaction style of the user with the GM that is specific to the user, GM input to generate GM output, the GM input including at least the user input; determine, based on the GM output, responsive content that reflects the particular interaction style; and cause the responsive content to be rendered at the client device of the user. In some implementations, the GM is supervise fine-tuned to learn the particular interaction style whereas, in other implementations, the GM is prompted to generate responsive content that reflects the particular interaction style.

### BACKGROUND

Various generative models (GMs) have been proposed that can be used to process image content, video content, audio content, natural language (NL) content (e.g., typed content or spoken content), and/or other input(s), to generate responsive content that is responsive to these input(s). These GMs are typically trained on enormous amounts of diverse data including data from, but not limited to, webpages, images, videos, electronic books, software code, electronic news articles, and machine translation data. Accordingly, in performing various tasks, these GMs leverage the underlying data on which they were trained, and optionally other data, such as user provided documents, search result documents obtained as part of a retrieval augmented generation (RAG) process, and so on, in generating the responsive content.

In addition to leveraging the underlying data on which they were trained and/or other data noted above, some of these GMs can have some form of memory to retain information about users. For example, some of these GMs can have memory to recall that a user is allergic to shellfish such that if the user asks for responsive content including a recipe, some of these GMs can refrain from including recipes that include shellfish in the responsive content. As another example, many of these GMs can build up a conversational context throughout a dialog session such that any responsive content that is generated responsive to a user input is not only based on the user input itself, but also the conversational context that is built up throughout the dialog session. However, current forms of memory and conversational context fail to consider how the user actually interacts with these GMs.

For instance, in the above example where the user asks for the responsive content including the recipe, but the user is allergic to shellfish, these GMs may only provide a recipe that does not include shellfish in the responsive content. However, these GMs may not have memory to recall that the user typically follows up these types of user inputs with a request to utilize a tool to determine whether the user has all of the ingredients needed for the recipe (e.g., via an application programming interface (API) call to a smart home application that has access to ingredients in a smart refrigerator). These and other drawbacks can be further exacerbated when there is no conversational context that has been built up (e.g., when the user asking for the responsive content including the recipe starts a new dialog). Since the user has to provide follow up user inputs, these and other drawbacks discussed herein waste computational and/or network resources.

### SUMMARY

Implementations described herein are directed to learning interaction style(s) of a user with a generative model (GM) based on prior interaction(s) between the user and the GM, and utilizing the interaction style(s) in generating responsive content during subsequent interaction(s). For example, processor(s) of a system can receive user input that is associated with a client device of a user; process, using GM and based on a particular interaction style of the user with the GM that is specific to the user, GM input to generate GM output, the GM input including at least the user input; determine, based on the GM output, responsive content that is responsive to the user input and that reflects the particular interaction style; and cause the responsive content to be rendered at the client device of the user. In some implementations, the GM is supervise fine-tuned, or otherwise trained, to learn the particular interaction style whereas, in other implementations, the GM is prompted to generate responsive content that reflects the particular interaction style.

Implementations disclosed herein can mitigate (e.g., eliminate) various drawbacks with current techniques that fail to consider how a user interacts with a GM. For example, by learning a user's interaction style (e.g., preference for using specific tools, grounding responses in search results, or formatting preferences), the system can proactively incorporate these preferences into subsequent responses, even in the absence of established conversational context. As another example, the system can predict and preemptively utilize the user's preferred interaction style, reducing the need for multiple user inputs to achieve the desired outcome. As another example, the learned interaction style can be used to tailor the GM's response generation, leading to more efficient and resource-conserving interactions. While a quantity of conserved resources may be relatively minimal on an user level, a quantity of conserved resources when considering an aggregated population of users (e.g., hundreds of thousands of users, millions of users, tens of millions of users, hundreds of millions of users, etc.) may be substantial and objectively lead to more efficient and resource-conserving interactions across the aggregated population of users.

In various implementations, the processor(s) can analyze conversation activity (also referred to as prior interactions) between the user and the GM, and can determine the particular interaction style based on analyzing the conversation activity. The particular interaction style can reflect, for example, prior extension/tool usage in the prior interaction(s) or robustness of prior extension/tool usage in the prior interaction(s) (e.g., a quantity of times that the user has utilized a particular extension or tool in requesting responsive content to the prior interaction(s)), prior extension/tool utilization in requesting certain types of responsive content in the prior interaction(s) or robustness of prior extension/tool utilization in requesting certain types of responsive content in the prior interaction(s) (e.g., a quantity of times that the user has utilized a particular extension or tool in requesting generative text content, generative code content, etc.), grounding of prior responsive content in search results in requesting the responsive content in the prior interaction(s) or an extent of grounding of prior responsive content in search results in requesting the responsive content in the prior interaction(s) (e.g., a quantity of times that the user has requested grounded prior responsive content in particular domain(s)/document(s)/search result(s), a quantity of times that the user has requested grounded prior responsive content in particular domain(s)/document(s)/search result(s) in requesting prior responsive content), and/or other interaction style(s) described herein.

Further, the processor(s) can determine the particular interaction style based on analyzing the conversation activity by, for example, identifying instructions included in prior user input(s) in the prior interaction(s), identifying instructions included in follow up user input(s) that follow prior user input(s) in the prior interaction(s), identifying feedback signal(s) received during the prior interaction(s) (e.g., positive feedback signal(s) that indicate the prior interaction(s) reflect a desired interaction style, negative feedback signal(s)) that indicate the prior interaction(s) do not reflect a desired interaction style), and/or based on other content of the prior interaction(s). In these and other manners, the processor(s)can determine the interaction style(s) described herein and optionally with varying degrees of granularity. For instance, a single interaction style for the user can be determined based on the conversation activity. Additionally, or alternatively, multiple interaction styles for the user can be determined based on the conversation activity and can vary based on a type of request that is included in user inputs from the conversation activity. The types of the request can include, for instance, a code generation request, a search result generation request, a text generation request, a text summarization request, an image generation request, a video generation request, and/or other types of requests. Accordingly, the processor(s) can dynamically adapt to these interaction style(s) based on requests included in user input(s).

As a non-limiting example of some implementations disclosed herein, consider a user who frequently provides user input associated with code generation tasks, such as different functions for different tasks to be utilized in an enterprise setting. The processor(s), after analyzing conversation activity where the user explicitly requested or implicitly indicated a preference for highly commented code through follow-up requests for clarification or modifications emphasizing the importance of comments, identifies this as the user's particular interaction style for the code generation tasks. Subsequently, when the user provides a new user input associated with a code generation task, the processor(s) can leverage this learned interaction style. For instance, in some implementations, the processor(s) can utilize this conversation activity to supervise fine-tune (SFT) the GM such that when the new user input is associated with the code generation task, the SFT'ed GM can generate highly commented code. Also, for instance, in additional or alternative implementations, the processor(s) can supplement the new user input with an indication that any responsive code should be highly commented and without having to SFT the GM. Accordingly, the resulting generated code can be richly annotated with detailed comments explaining the purpose and functionality of each code section. This proactive approach ensures the generated code aligns with the user's established preference, reducing the likelihood of follow-up requests for additional comments and optimizing the overall interaction efficiency while mitigating and/or eliminating instances where the follow up user inputs requesting the generated code be highly commented.

The above description is provided as an overview of some implementations of the present disclosure. Further description of those implementations, and other implementations, are described in more detail below.

### BRIEF DESCRIPTION OF THE DRAWINGS

FIG. 1 depicts a block diagram of an example environment that demonstrates various aspects of the present disclosure, and in which some implementations disclosed herein can be implemented.

FIG. 2 depicts a flowchart illustrating an example method of analyzing conversation activity between a user and a GM to determine interaction style(s) of the user with the GM, and optionally fine-tuning a given GM based on the interaction style(s), in accordance with various implementations.

FIG. 3 depicts a flowchart illustrating an example method of utilizing interaction style(s) of a user with a GM in generating responsive content, in accordance with various implementations.

FIG. 4A and FIG. 4B depict various non-limiting examples of conversation activity between a user and a GM based on which interaction style(s) are determined, in accordance with various implementations.

FIGS. 5A and 5B depict various non-limiting examples of utilizing interaction style(s) of a user with a GM in generating responsive content, in accordance with various implementations.

FIG. 6 depicts an example architecture of a computing device, in accordance with various implementations.

### DETAILED DESCRIPTION

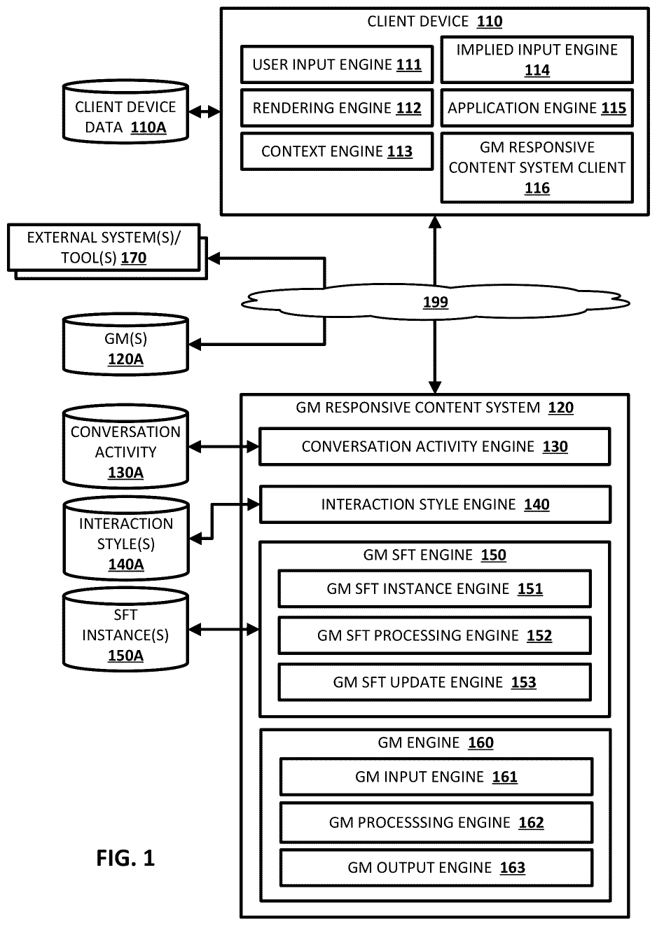

Turning now to FIG. 1, a block diagram of an example environment that demonstrates various aspects of the present disclosure, and in which implementations disclosed herein can be implemented is depicted. A client device 110 is illustrated in FIG. 1, and includes, in various implementations, a user input engine 111, a rendering engine 112, and a generative content system client 113. The client device 110 may be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, a video game console, and/or a wearable apparatus of the user that includes a computing device (e.g., a watch of the user having a computing device, glasses of the user having a computing device, a virtual or augmented reality computing device, etc.). Additional and/or alternative client devices may be provided.

Turning now to FIG. 1, a block diagram of an example environment that demonstrates various aspects of the present disclosure, and in which implementations disclosed herein can be implemented is depicted. The example environment includes a client device 110, a generative model (GM) responsive content system 120, and external system(s)/tool(s) 170. Although illustrated separately, in some implementations, all or aspects of the GM responsive content system 120 can be implemented locally at the client device 110 (e.g., via GM responsive content system client 116). In additional or alternative implementations, all or aspects of the GM responsive content system 120 can be implemented remotely from the client device 110 as depicted in FIG. 1 (e.g., at remote server(s)). In those implementations, the client device 110 and the GM responsive content system 120 can be communicatively coupled with each other via one or more networks 199, such as one or more wired or wireless local area networks (“LANs,” including Wi-Fi® LANs, mesh networks, Bluetooth®, near-field communication, etc.) or wide area networks (“WANs”, including the Internet). Further, the client device 110 and/or the GM responsive content system 120 can interact with the external system(s)/tool(s) 170 via one or more of the networks 199.

The client device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided.

The client device 110 can execute one or more software applications, via application engine 115, through which user input(s) can be submitted and/or responsive content (e.g., that is responsive to the user input(s)) can be rendered (e.g., audibly and/or visually). The application engine 115 can execute one or more software applications that are separate from an operating system of the client device 110 (e.g., one installed “on top” of the operating system)—or can alternatively be implemented directly by the operating system of the client device 110. For example, the application engine 115 can execute a web browser installed on top of the operating system of the client device 110, or the web browser can be a software application that is integrated as part of the operating system of the client device 110. The application engine 115 (and the one or more software applications executed by the application engine 115) can interact with the GM responsive content system 120, and optionally via a dedicated generative content software application, an automated assistant, or the like.

In various implementations, the client device 110 can include a user input engine 111 that is configured to detect user input provided by a user of the client device 110 using one or more user interface input devices. For example, the client device 110 can be equipped with one or more microphones that capture audio data, such as audio data corresponding to spoken utterances of the user or other sounds in an environment of the client device 110. Additionally, or alternatively, the client device 110 can be equipped with one or more vision components that are configured to capture vision data corresponding to images and/or movements (e.g., gestures) detected in a field of view of one or more of the vision components. Additionally, or alternatively, the client device 110 can be equipped with one or more touch sensitive components (e.g., a keyboard and mouse, a stylus, a touch screen, a touch panel, one or more hardware buttons, etc.) that are configured to capture signal(s) corresponding to typed input and/or touch input directed to the client device 110.

Some instances of a user input described herein can be a prompt or query for responsive content that is formulated based on user input provided by a user of the client device 110 and detected via user input engine 111. For example, the prompt or query can be a typed prompt or query that is typed via a physical or virtual keyboard, a suggested prompt or query that is selected via a touch screen or a mouse of the client device 110, a spoken voice prompt or voice query that is detected via microphone(s) of the client device 110, or an image prompt or query that is based on an image or video captured by vision component(s) of the client device 110 (or based on a prompt or query generated based on processing the image or video using, for example, object detection model(s), captioning model(s), etc.). Other instances of user input are contemplated herein.

In various implementations, the client device 110 can include a rendering engine 112 that is configured to render responsive content, an indication of source(s) associated with the responsive content, and/or other content for audible and/or visual presentation to a user of the client device 110. For example, the client device 110 can be equipped with one or more speakers that enable the responsive content to be provided for audible presentation to the user via the client device 110. Additionally, or alternatively, the client device 110 can be equipped with a display or projector that enables the content to be provided for visual presentation to the user via the client device 110.

In various implementations, the client device 110 can include a context engine 113 that is configured to determine a context (e.g., current or recent context) of the client device 110 and/or of a user of the client device 110 (e.g., an active user of the client device 110 when the client device 110 is associated with multiple users). In some versions of those implementations, the context engine 113 can determine a context based on data stored in client device data database 110A. The data stored in the client device data database 110A can include, for example, user interaction data that characterizes current or recent interaction(s) of the client device 110 and/or of a user of the client device 110, location data that characterizes a current or recent location(s) of the client device 110 and/or of a user of the client device 110, user attribute data that characterizes one or more attributes of a user of the client device 110, user preference data that characterizes one or more preferences of a user of the client device 110, user profile data that characterizes a profile of a user of the client device 110, and/or other data associated with the client device 110 and/or a user of the client device 110.

For example, the context engine 113 can determine a current context based on a current state of a dialog session (e.g., considering one or more recent prompts or queries provided by a user during the dialog session, responsive content provided by the GM responsive content system 120 during the dialog session), profile data, and/or a current location of the client device 110. For instance, the context engine 113 can determine a current context of “visitor looking for popular events in Louisville, Kentucky” based on a recently issued prompt or query, profile data, and an anticipated future location of the client device 110 (e.g., based on recently booked hotel accommodations and/or flight accommodations). As another example, the context engine 113 can determine a current context based on which software application is active in the foreground of the client device 110, a current or recent state of the active software application, and/or content currently or recently rendered by the active software application. A context determined by the context engine 113 can be utilized, for example, in supplementing or rewriting a prompt or query that is formulated based on user input, in generating an implied prompt or implied query (e.g., a query or prompt formulated independent of user input), and/or in determining to submit an implied prompt or implied query and/or to render result(s) (e.g., responsive content) for an implied prompt or implied query.

In various implementations, the client device 110 can include an implied input engine 114 that is configured to: generate an implied prompt or implied query independent of any user input directed to formulating the implied query or the implied prompt; to submit an implied prompt or implied query, optionally independent of any user input that requests submission of the implied prompt or implied query; and/or to cause rendering of search result(s) or a responsive content for an implied prompt or implied query, optionally independent of any user input that requests rendering of the search result(s) or the responsive content. For example, the implied input engine 114 can use one or more past or current contexts, from the context engine 113, in generating an implied prompt or implied query, determining to submit the implied query or the implied prompt, and/or in determining to cause rendering of search result(s) or responsive content that is responsive to the implied query or the implied prompt. For instance, the implied input engine 114 can automatically generate and automatically submit an implied prompt or implied query based on the one or more past or current contexts. Further, the implied input engine 114 can automatically push the search result(s) or the responsive content that is generated responsive to the implied prompt or implied query to cause them to be automatically rendered or can automatically push a notification of the search result(s) or the responsive content, such as a selectable notification that, when selected, causes rendering of the search result(s) or the responsive content. Additionally, or alternatively, the implied input engine 114 can submit the implied query or the implied prompt at regular or non-regular intervals, and cause the search result(s) or the responsive content for the submission(s) to be automatically provided (or a notification thereof automatically provided). For instance, the implied query or the implied prompt can be “patent news” based on the one or more past or current contexts indicating a user's general interest in patents, the implied query or the implied prompt periodically submitted, and the search result(s) or the responsive content can be automatically provided (or a notification thereof automatically provided). It is noted that the provided search result(s) or responsive content result can vary over time in view of, e.g., presence of new/fresh search result document(s) over time.

Further, the client device 110 and/or the GM responsive content system 120 can include one or more memories for storage of data and/or software applications, one or more processors for accessing data and executing the software applications, and/or other components that facilitate communication over one or more of the networks 199. In some implementations, one or more of the software applications can be installed locally at the client device 110, whereas in other implementations one or more of the software applications can be hosted remotely (e.g., by one or more servers) and can be accessible by the client device 110 over one or more of the networks 199.

Although aspects of FIG. 1 are illustrated or described with respect to a single client device having a single user, it should be understood that is for the sake of example and is not meant to be limiting. For example, one or more additional client devices of a user and/or of additional user(s) can also implement the techniques described herein. For instance, the client device 110, the one or more additional client devices, and/or any other computing devices of a user can form an ecosystem of devices that can employ techniques described herein. These additional client devices and/or computing devices may be in communication with the client device 110 (e.g., over the network(s) 199). As another example, a given client device can be utilized by multiple users in a shared setting (e.g., a group of users, a household, a workplace, a hotel, etc.).

The GM responsive content system 120 is illustrated in FIG. 1 as including a conversation activity engine 130, an interaction style engine 140, a GM supervised fine-tuning (SFT) engine 150, and a GM engine 160. Some of these engines can be combined and/or omitted in various implementations. Further, these engines can include various sub-engines. For instance, the GM SFT engine 150 is illustrated in FIG. 1 as including a GM SFT instance engine 151, a GM SFT processing engine 152, and a GM SFT update engine 153. Further, the GM engine 160 is illustrated in FIG. 1 as including GM input engine 161, GM processing engine 162, and GM output engine 163. Some of these sub-engines can be combined and/or omitted in various implementations. Accordingly, it should be understood that the various engines and sub-engines of the GM responsive content system 120 illustrated in FIG. 1 are depicted for the sake of clarity and are not meant to be limiting.

Further, the GM responsive content system 120 is illustrated in FIG. 1 as interfacing with various databases, such as conversation activity database 130A, interaction style(s) database 140A, and SFT instance(s) database 150A. Although particular engines and/or sub-engines are depicted as having access to particular databases, it should be understood that is for the sake of example and is not meant to be limiting. For instance, in some implementations, each of the various engines and/or sub-engines of the GM responsive content system 120 may have access to each of the various databases. However, in some other implementations, one or more of the various databases may be access-restricted. Moreover, in various implementations, the client device 110 and/or the GM responsive content system 120 can have access to GM(s) stored in GM(s) database 120A that stores the GM(s) described herein. In some implementations, a GM can be an on-device GM that is executed locally at the client device 110 whereas, in additional or alternative implementations, a GM can be a remote GM that is executed remotely from the client device.

As described herein, a GM can be any sequence-to-sequence based machine learning model capable of generating generative vision data, generative audio data, generative textual data, and/or other forms of generative data. Some non-limiting examples of sequence-to-sequence based machine learning models that are capable of generating one or more forms of the generative data noted above include transformer-based machine learning models (e.g., encoder-decoder transformer models, encoder-only transformer models, decoder-only transformer models, etc. that optionally employ an attention mechanism or some other form of memory), stable diffusion-based machine learning models, recurrent neural network-based machine learning models, generative adversarial network-based machine learning models, etc. Various sequence-to-sequence based machine learning models have demonstrated multimodal capabilities in that they are capable of processing inputs in various modalities (e.g., text-based inputs, vision-based inputs, audio-based inputs, etc.) and generating outputs in various modalities (e.g., text-based output, vision-based outputs, audio-based generative outputs, etc.). Some particular non-limiting examples of these sequence-to-sequence based machine learning models that have demonstrated multimodal capabilities include the Gemini family of models, the ChatGPT family of models, the Claude family of models, the Llama family of models, and/or other families of sequence-to-sequence generative models.

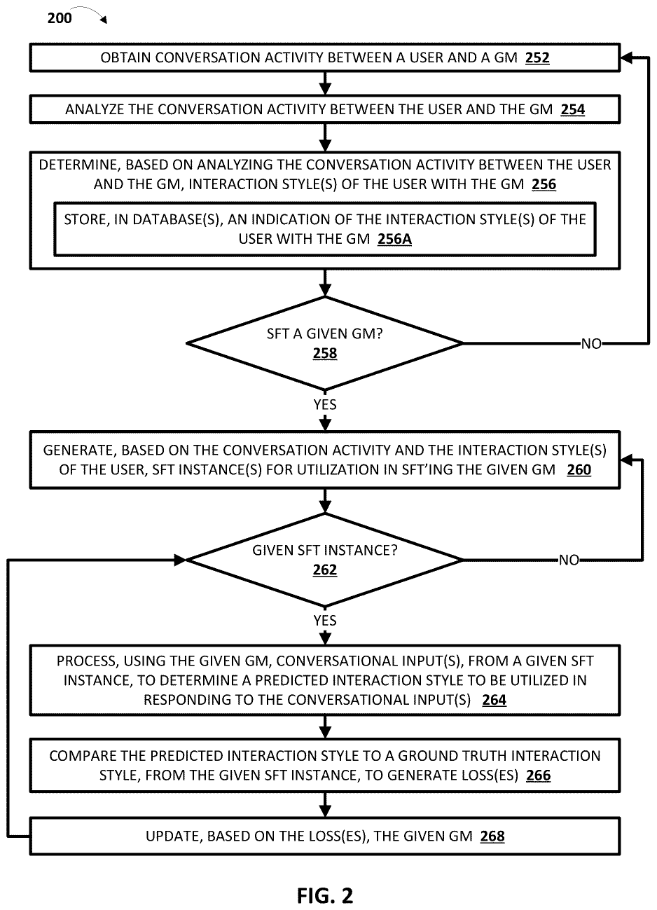

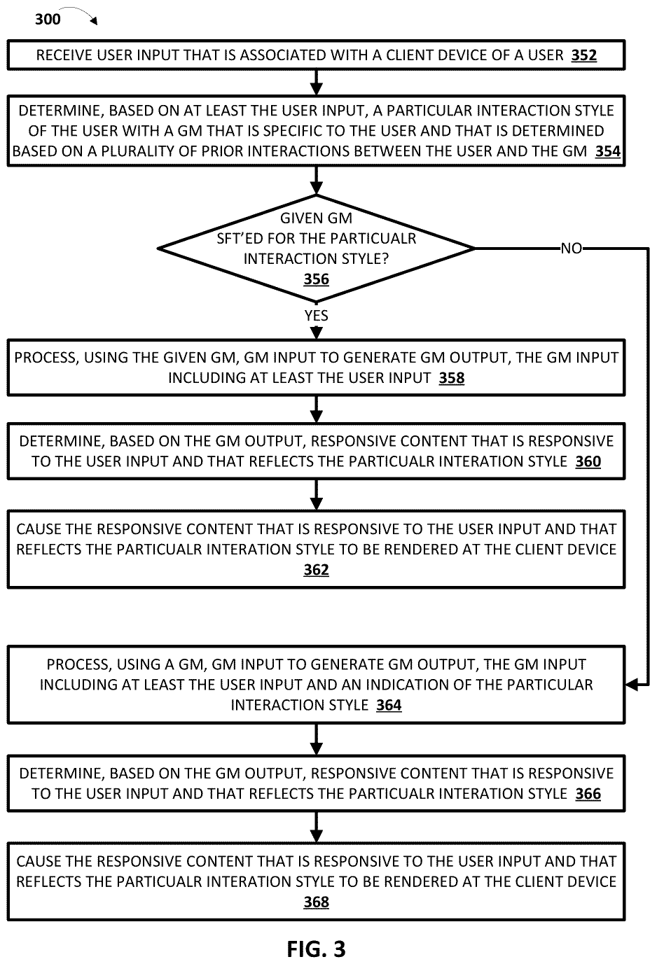

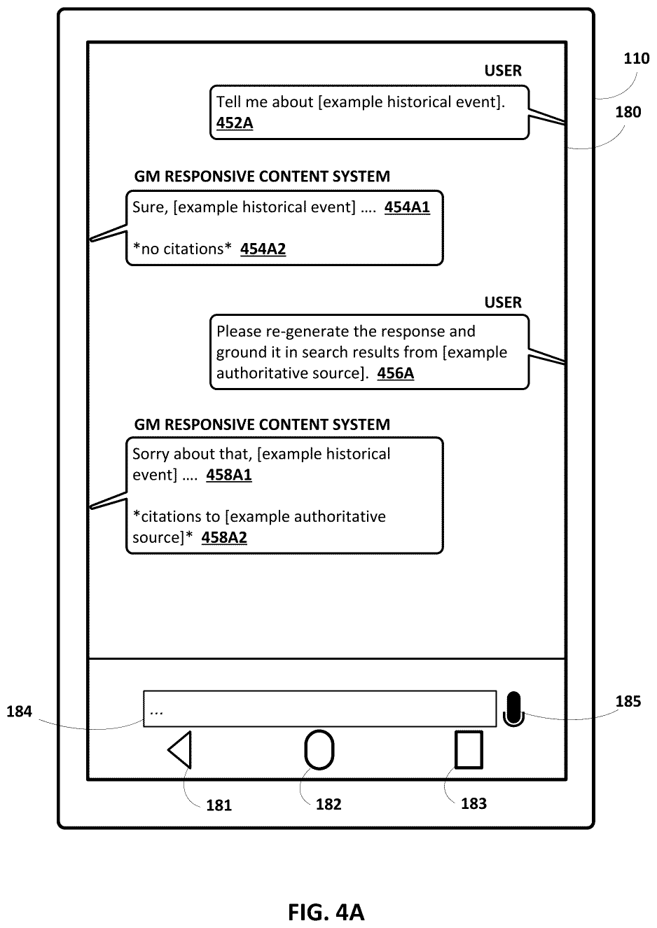

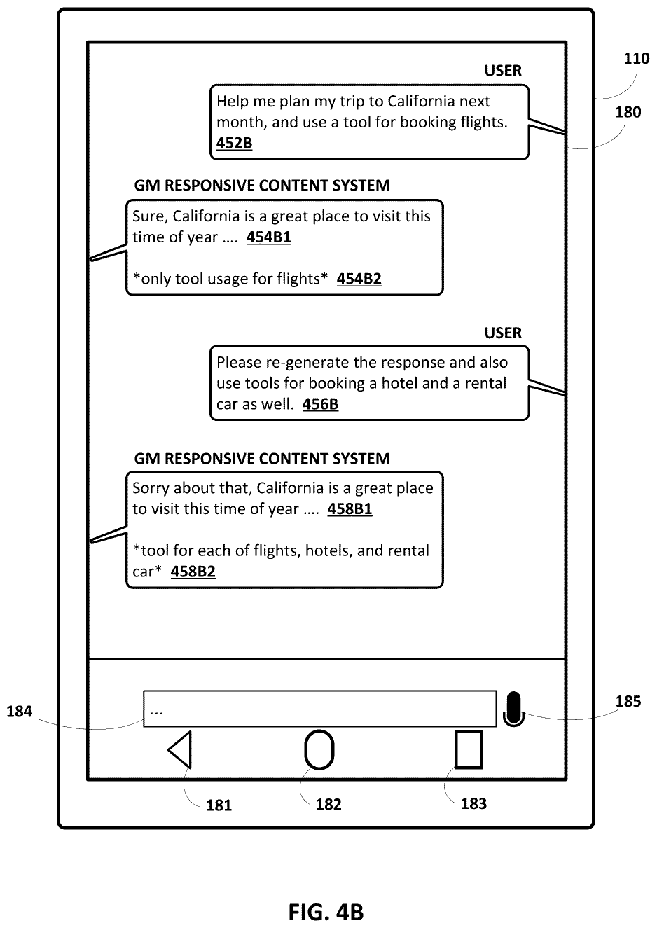

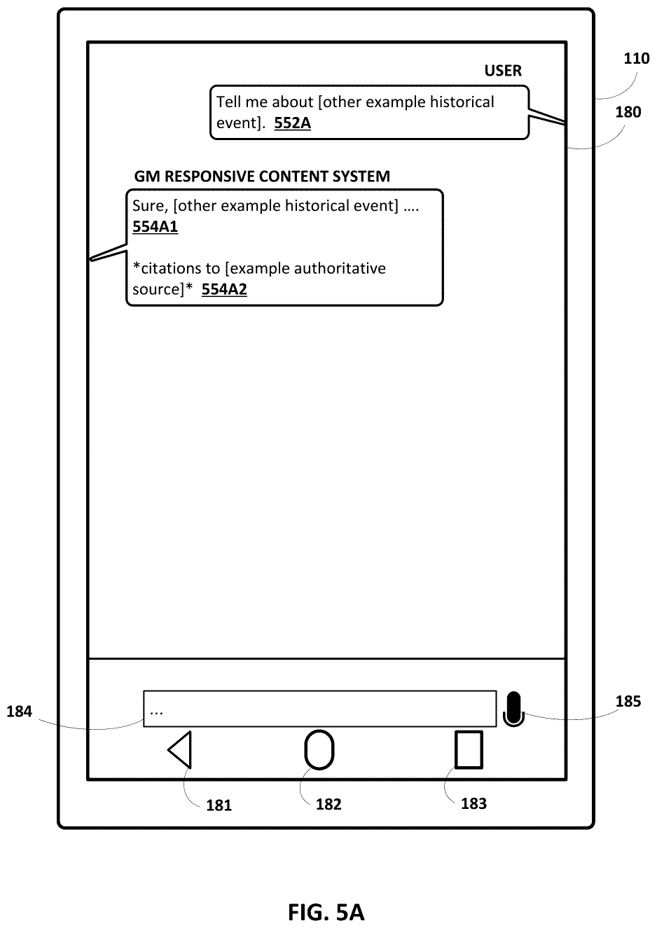

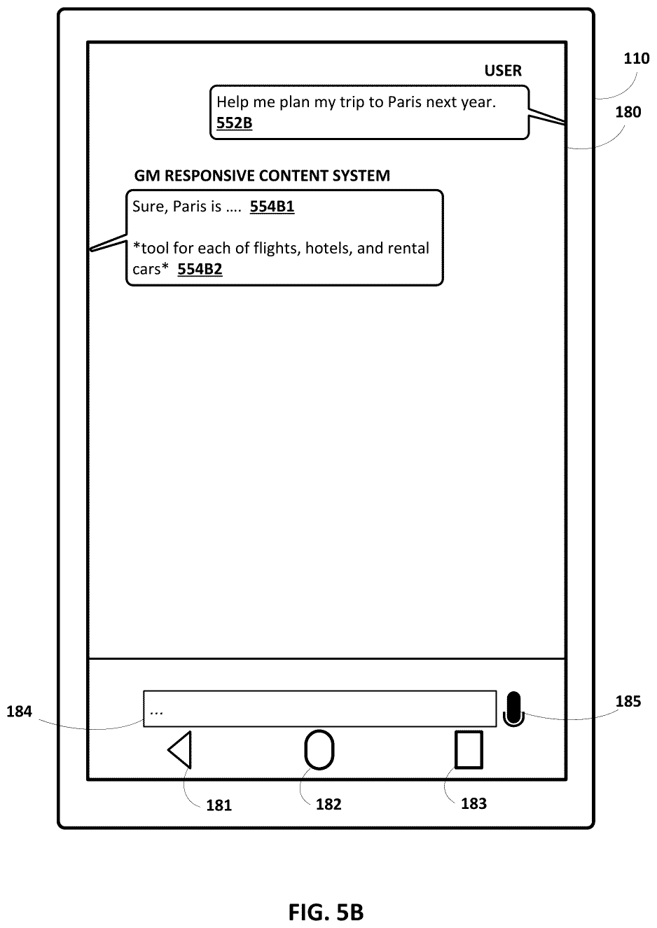

As described in more detail herein, the GM responsive content system 120 (or the GM responsive content system client 116) can be initially utilized to analyze conversation activity between a user and a GM to determine interaction style(s) of the user with the GM. The interaction style(s) can be determined based on, for example, historical extension/tool usage of the user in requesting prior responsive content, historical robustness of extension/tool usage of the user in requesting prior responsive content, historical grounding of prior responsive content in search results in requesting prior responsive content, an extent of historical grounding of prior responsive content in search results in requesting prior responsive content, historical commenting of code by the user in requesting prior responsive content, or historical robustness of commenting of code by the user in requesting prior responsive content., and/or based on other factors that characterize how the user interacts with the GM. In some implementations, and as described with respect to FIGS. 2 and 3, the interaction style(s) can be stored and utilized to supplement user input at inference time to generate responsive content that reflects the interaction style(s) of the user with the GM and/or can be utilized to SFT a given GM such that responsive content that is generated using the given GM at inference time reflects the interaction style(s) of the user with the given GM at inference time. Some non-limiting examples of conversation activity between a user and a GM are provided herein (e.g., with respect to FIGS. 4A and 4B). Further, some non-limiting examples of utilizing these interaction style(s) are provided herein (e.g., with respect to FIGS. 5A and 5B).

By determining these interaction style(s) based on analyzing the conversation activity between the user and the GM, and by utilizing the interaction style(s) to supplement user input and/or to SFT a given GM, the GM responsive content system 120 (or the GM responsive content system client 116) can generate responsive content that reflects these interaction style(s), thereby reducing a number of user inputs that are required to obtain responsive content that satisfies one or more conversational (e.g., interaction) goals of the user and reducing waste of computational and/or network resources that would have otherwise be consumed as a consequence of generating responsive content that does not reflect the interaction style(s) of the user with the GM.

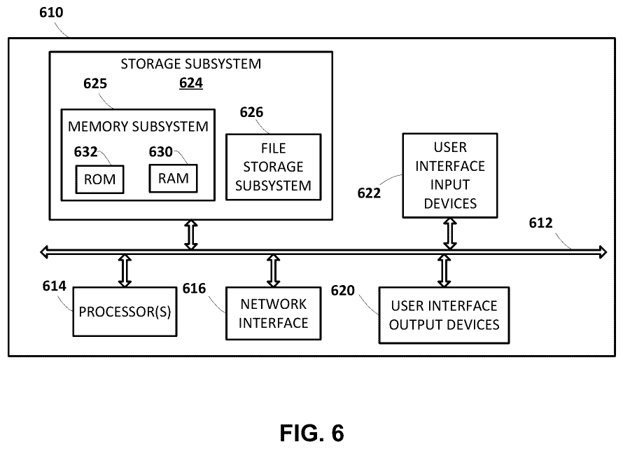

Turning now to FIG. 2, a flowchart illustrating an example method 200 of analyzing conversation activity between a user and a GM to determine interaction style(s) of the user with the GM, and optionally fine-tuning a given GM based on the interaction style(s), is depicted. For convenience, the operations of the method 200 are described with reference to a system that performs the operations. This system of the method 200 includes one or more processors, memory, and/or other component(s) of computing device(s) (e.g., client device 110 of FIG. 1, GM responsive content system 120 of FIG. 1, computing device 610 of FIG. 6, one or more servers, and/or other computing devices). Moreover, while operations of the method 200 are shown in a particular order, this is not meant to be limiting. One or more operations may be reordered, omitted, and/or added.

At block 252, the system obtains conversation activity between a user and a GM. For example, the system can cause the conversation activity engine 130 to obtain the conversation activity from the conversation activity database 130A. In some implementations, the conversation activity stored in the conversation activity database 130A can be a subset of information stored in client device data database 110A. Notably, the conversation activity can include, for example, previous conversation(s) between the user and the GM, previous interactions of the user with the GM, and/or other conversational (e.g., interaction) data of the user with the GM. For instance, for a given conversation, the conversation activity can include a user input, any instructions included in the user input, an indication of a type of request(s) included in the user input, responsive content that is responsive to the user input, an indication of a type of content included in the responsive content, an indication of any feedback received with responsive content (e.g., positive user input in the form of a “thumbs up”, negative user feedback in the form of a “thumbs down”), follow up user inputs that are follow ups to the responsive content, any instructions included in the follow up user input, and/or other conversational data.

At block 254, the system analyzes the conversation activity between the user and the GM. At block 256, the system determines, based on analyzing the conversation activity between the user and the GM, one or more interaction styles of the user with the GM. For example, the system can cause the interaction style engine 140 to analyze the conversation activity obtained at the operations of block 252, and to determine the one or more interaction styles based on analyzing the conversation activity. As noted above with respect to FIG. 1, the one or more interaction styles can be determined based on, for example, historical extension/tool usage of the user in requesting prior responsive content, historical robustness of extension/tool usage of the user in requesting prior responsive content, historical grounding of prior responsive content in search results in requesting prior responsive content, an extent of historical grounding of prior responsive content in search results in requesting prior responsive content, historical commenting of code by the user in requesting prior responsive content, or historical robustness of commenting of code by the user in requesting prior responsive content., and/or based on other factors that characterize how the user interacts with the GM and/or based on other factors that characterize how the user interacts with the GM.

In some implementations, the interaction style engine 140 can determine the interaction style(s) of the user based on the types of the user inputs, the types of follow up user inputs, and/or other features of the conversation activity. For example, the interaction style engine 140 can determine the interaction style(s) based on instructions included in conversational inputs. For instance, the instructions included in the conversational inputs can instruct the GM to utilize specific extensions/tools, instruct the GM to utilize specific extensions/tools for specific types of users inputs, instruct the GM to ground any responsive content into specific domains/documents/search results, instruct the GM to ground any responsive content into specific document/search results for specific types of user inputs, instruct the GM to include comments in any responsive content that includes code, instruct the GM to include comments in any responsive content that is associated with specific code, and/or other instructions that can be utilized in characterizing how the user interacts with the GM. Notably, these instructions included in the conversational inputs can be based on, for example, initial user inputs that request responsive content, follow up user inputs that are follow ups to responsive content being rendered. Also, for example, the interaction style engine 140 can determine the interaction style(s) based on feedback signals associated with responsive content provided responsive to the conversation inputs. For instance, the feedback signals can include positive feedback signals with respect to responsive content provided responsive to the conversational input(s), negative feedback signals with respect to responsive content provided responsive to the conversational input(s), and/or other types of feedback signal associated with responsive content provided responsive to the conversational input(s). These feedback signals can be, for example, binary feedback signals (e.g., a “thumbs up” directed to responsive content indicating a positive feedback signal, or a “thumbs down” directed to responsive content indicating a negative feedback signal) or based on follow up user inputs that are follow ups to responsive content being rendered (e.g., “thanks for using that extension/tool” or “thanks for commenting that code for me” indicating a positive feedback signal, or “why didn't you use any extension/tool” or “why didn't you comment that code for me” indicating a negative feedback signal).

It should be understood that instructions included in conversational inputs and/or the feedback signals associated with responsive content are virtually limitless and, as a result, the interaction style(s) determined by the interaction style engine 140 are virtually limitless. Nonetheless, various non-limiting examples of conversation activity are described herein (e.g., with respect to FIGS. 4A and 4B), and various non-limiting examples of how the interaction style(s) determined based on the conversation activity can impact how the user interacts with the GM and based on the interaction style(s) are described herein (e.g., with respect to FIGS. 5A and 5B). Further, it should be understood that the interaction style(s) described herein can be defined with varying degrees of granularity. For instance, a single interaction style for the user can be determined based on the conversation activity. Additionally, or alternatively, multiple interaction styles for the user can be determined based on the conversation activity and can vary based on a type of request that is included in user inputs from the conversation activity. The types of the request can include, for instance, a code generation request, a search result generation request, a text generation request, a text summarization request, an image generation request, a video generation request, and/or other types of requests.

At sub-block 256A, the system can store, in one or more databases, an indication of the one or more interaction styles of the user with the GM. For example, the system can cause the interaction style(s) engine 140 to store an indication of the one or more interaction styles in the interaction styles database 140A. In some implementations, and as described with respect to FIG. 3, the indication of the one or more interaction styles can be subsequently utilized to supplement user input(s) that are received at inference time and to generate responsive content that reflects the interaction style(s) of the user with the GM. In additional or alternative implementations, and as described with respect to the operations of blocks 260, 262, 264, 266, and 268 of FIG. 2, the indication of the one or more interaction styles can be subsequently utilized to SFT a given GM such that responsive content that is generated using the given GM at inference time reflects the interaction style(s) of the user with the given GM. In these implementations, and as described with respect to FIG. 4, the given GM can be utilized in generating responsive content that reflects the interaction style(s) of the user with the given GM by virtue of the given GM being SFT based on the indication of the one or more interaction styles.

At block 258, the system determines whether to SFT a given GM. The system can determine whether to SFT the given GM based on, for example, instructions provided by a developer of the system that is associated with the given GM, whether the given GM is local to a client device of the user, whether the given GM is capable of being SFT'ed locally at the client device of the user, and/or based on other factors. Notably, in implementations where the given GM is SFT'ed, the conversation activity utilized to determine the one or more interaction styles can be utilized in generating SFT instance(s) for SFT'ing the given GM and, as a result, it may be desirable to do so locally at the client device of the user due to privacy and/or data security considerations. If, at an iteration of block 258, the system determines not to SFT a given GM, then the system returns to block 252 to continue obtaining conversation activity between a user and a GM. The system can perform an additional iteration of the operations of blocks 252, 254, and 256 to continue determining the one or more interaction styles of the user with the GM based on additional conversation activity between the user and the GM that is obtained which, as noted above, can vary based on types of requests included in the user inputs from the conversation activity.

If, at an iteration of block 258, the system determines to SFT a given GM, the system proceeds to block 260. At block 260, the system generates, based on the conversation activity and the one or more interaction styles, one or more SFT instances for utilization in SFT'ing the given GM. For example, the system can cause the GM SFT instance engine 151 to generate the one or more SFT instances for utilization in SFT'ing the given GM. Each of the one or more SFT instances can include, for example, at least conversational input(s) (e.g., including user input(s), responsive content, feedback signal(s), etc.) from the conversation activity that was analyzed to determine the one or more interaction styles of the user with the GM and a ground truth interaction style that was determined based on the conversational input(s). Put another way, the conversational input(s) and/or feedback signal(s) can be the conversation activity that was processed to determine the one or more interaction styles of the user with the GM and the ground truth interaction style can include the one or more interaction styles of the user with the GM.

At block 262, the system determines whether there is a given SFT instance to be utilized in SFT'ing the given GM. If, at an iteration of block 262, the system determines that there is not a given SFT instance to be utilized in SFT'ing the given GM, then the system returns to block 260 to generate one or more additional SFT instances for utilization in SFT'ing the given GM. Notably, at a first iteration of the operations of block 262, the system may have recently generated one or more SFT instances for utilization in SFT'ing the given GM, so the system can proceed to block 264. However, at subsequent iterations of the operations of block 262, the system may need to return to block 260 to generate one or more additional SFT instances for utilization in SFT'ing the given GM.

If, at an iteration of block 262, the system determines that there is a given SFT instance to be utilized in SFT'ing the given GM, then the system proceeds to block 264. At block 264, the system processes, using the given GM, one or more conversational inputs, from a given SFT instance, to determine a predicted interaction style to be utilized in responding to one or more of the conversational inputs. For example, the system can cause the GM SFT processing engine 152 to process, using the given GM, the one or more conversational inputs from the given SFT instance to determine the predicted interaction style to be utilized in responding to one or more of the conversational inputs. Notably, the one or more conversational inputs can include, for example, user input(s), feedback signal(s) provided responsive to the user input(s), instruction(s) embedded in the user input(s), and/or other conversational inputs. Further, the predicted interaction style can include, for example, an indication that the GM should utilize a particular type of extension/tool, an indication that the GM should not utilize a particular type of extension/tool, an indication that the GM should ground any responsive content into a specific domain/document/search result, an indication that the GM should ground any responsive content into a specific document/search result for a specific type of user input, an indication that the GM should include a comment in any responsive content that includes code, an indication that the GM should include a comment in any responsive content that is associated with a specific code, and/or other an indication of other interaction style(s).

At block 266, the system compares the predicted interaction style to a ground truth interaction style, from the given SFT instance, to generate one or more losses. At block 268, the system updates, based on the one or more losses, the given GM. For example, the system can cause the GM SFT update engine 153 to compare the predicted interaction style to the ground truth interaction style to generate the one or more losses, and cause the given GM to be updated based on the one or more losses. In some implementations, and in comparing the predicted interaction style to the ground truth interaction style, the GM SFT update engine 153 can determine a corresponding embedding (or other lower-level representation) of the predicted interaction style and the ground truth interaction style, and compare the predicted interaction style and the ground truth interaction style in an embedding space (or other lower-level space). For example, the GM SFT engine 153 could use sentence embeddings (e.g., Sentence-BERT) to generate a corresponding vector representation of the predicted interaction style and the ground truth interaction style. In this example, a cosine similarity score could then be calculated between these corresponding vector representations, and the loss could be defined as 1 minus the cosine similarity. Additionally, or alternatively, a contrastive loss function could be used, where the goal is to maximize the similarity between the predicted and ground truth embeddings while minimizing the similarity between the predicted embedding and embeddings from other interaction styles.

In additional or alternative implementations, and in comparing the predicted interaction style to the ground truth interaction style, the GM SFT update engine 153 can directly compare the predicted interaction style and the ground truth interaction style to determine the one or more losses. For example, assume that the predicted interaction style is determined based on a probability distribution over a sequence of interaction styles generated based on processing the conversational input(s), and the predicted interaction style is associated with a highest probability in the probability distribution. In this example, the GM SFT update engine 153 can compare the probability distribution (e.g., based on which the predicted interaction style was determined) with a ground truth probability distribution (e.g., that is associated with the ground truth interaction style) to determine the one or more losses. Accordingly, it should be understood that the system can utilize various techniques in comparing the predicted interaction style to the ground truth interaction style to determine the one or more losses which, in turn, can be utilized in updating the given GM.

The system can return to block 262 and perform an additional iteration of the operations of blocks 262, 264, 266, and 268 to continue SFT'ing the given GM based on one or more additional SFT instances. In some implementations, the given GM can be SFT'ed for a particular interaction style such that multiple given GMs are SFT'ed for different interaction styles determined based on analyzing the conversation activity by using multiple iterations of the method 200 of FIG. 2 (e.g., in a parallel manner and/or in a serial manner). In these implementations, and at inference time, a given GM can be selected for processing a user input based on, for example, a type of request that is included in the user input, instructions that are included in the user input, a domain to which the user input is directed, a context associated with the user input, and/or other information. In additional or alternative implementations, the given GM can be SFT'ed for multiple interaction styles. In these implementations, and at inference time, the system need not select a given GM from multiple given GM(s) for processing the user input.

Although the method 200 of FIG. 2 is described with respect to SFT'ing GM(s) based on the determined interaction style(s), it should be understood that is for the sake of example and is not meant to be limiting. For example, and as noted above with respect to the operations of block 258, the system can simply store the interaction style(s) and utilize the interaction style(s) to supplement user input at inference time without SFT'ing any GM. Additionally, or alternatively, the system can utilize the determined interaction style(s) to generate reinforcement learning from human feedback (RLHF) instances for RLHF training of a GM(s) in addition to, or in lieu of, SFT'ing the GM(s) as described above. In implementations where the system utilizes RLHF to train the GM(s), the conversational input(s) can be provided for presentation to a user and/or a developer of the GM(s) along with an indication of the predicted interaction style, and the user and/or the developer can provide feedback signal(s) that indicate whether the predicted interaction style is correct given the conversational input(s). Further, the system can process, using a reward model, the feedback signal(s) to generate a reward that can be utilized to update the GM(s).

Turning now to FIG. 3, a flowchart illustrating an example method 300 of utilizing interaction style(s) of a user with a GM in generating responsive content is depicted. For convenience, the operations of the method 300 are described with reference to a system that performs the operations. This system of the method 300 includes one or more processors, memory, and/or other component(s) of computing device(s) (e.g., client device 110 of FIG. 1, GM responsive content system 120 of FIG. 1, computing device 610 of FIG. 6, one or more servers, and/or other computing devices). Moreover, while operations of the method 300 are shown in a particular order, this is not meant to be limiting. One or more operations may be reordered, omitted, and/or added.

At block 352, the system receives user input that is associated with a client device of a user. For example, the system can receive typed input, voice-based input, or touch-based input of the user that was directed to the client device (e.g., and that is detected by the user input engine 111).

At block 354, the system determines, based on at least the user input, a particular interaction style of the user with a GM that is specific to the user and that is determined based on a plurality of prior interactions between the user and the GM. For example, the system can cause the interaction style engine 140 to determine the particular interaction style based on the user input and/or other conversation activity of a current conversation between the user and the GM. Similar to the operations of block 256 of FIG. 2, the particular interaction style can be determined based on, for example, instructions included in the user input, a type of request included in the user input, a context of a conversation between the user and the GM, and/or based on other factors contemplated herein.

At block 356, the system determines whether there is a given GM SFT'ed for the particular interaction style. For example, if the system previously SFT'ed a given GM for the particular interaction style (e.g., using the operations of block 260, 262, 264, 266, and 268 of the method 200 of FIG. 2), then the system can determine that there is a given GM SFT'ed for the particular interaction style. Further, in implementations where multiple given GMs are SFT'ed for different interaction styles, the system can also select the given GM SFT'ed for the particular interaction style and from among a plurality of given GMs SFT'ed for different interaction styles. Conversely, if the system has not yet SFT'ed a given GM for the particular interaction style, then the system can determine that there is not a given GM SFT'ed for the particular interaction style.

If, at an iteration of block 356, the system determines that there is a given GM SFT'ed for the particular interaction style, then the system proceeds to block 358. At block 358, the system processes, using the given GM, GM input to generate GM output, the GM input including at least the user input. For example, the system can cause the GM input engine 161 to process the user input to generate the GM input. As noted, the GM input can include the user input, any conversation context for a conversation during which the user input was provided, any user context associated with the user that provided the user input, and/or any other context information. For instance, the GM input engine 161 can utilize a tokenizer to tokenize this information such that it is in a suitable form for processing by the given GM. In some implementations, the GM input engine 161 can also generate an indication of extension(s)/tool(s) to invoke by the given GM and in furtherance of generating responsive content that is responsive to the GM input, an indication of a retrieval augmented generation (RAG) process to perform by the given GM to obtain document(s)/search result(s) based on which responsive content that is responsive to the GM input can be grounded, and/or cause other action(s) to be performed. In these implementations, any content obtained using the extension(s)/tool(s), obtained using a RAG process, and/or based on other action(s) can be included in the GM input.

Further, the system can cause the GM processing engine 162 to process, using the given GM, the GM input to generate the GM output. The GM output can include, for example, probability distribution(s) over sequence(s) of token(s) based on which text-based output and/or audio-based output can be generated. For example, in implementations where the output includes text-based output, the GM output can be a probability distribution over a sequence of word units, words, phrases, etc. As another example, in implementations where the output includes audio-based output, the GM output can include a probability distribution over audio units, phonemes, etc.

At block 360, the system determines, based on the GM output, responsive content that is responsive to the user input and that reflects the particular interaction style. For example, the system can cause the GM output engine 163 to determine, based on the GM output, the responsive content that is responsive to the user input and that reflects the particular interaction style. For example, the GM output engine 163 can utilize one or more decoding techniques to determine the responsive content and based on the probability distribution(s) over the sequence(s) of token(s). For example, the GM output engine 163 can utilize a greedy decoding technique, a beam search technique, a nucleus sampling technique, a top-k sampling technique, and/or other decoding techniques to process the probability distribution(s) over the sequence(s) of token(s) and generate the responsive content. Various non-limiting examples of responsive content that reflect the particular interaction style of the user are described herein (e.g., with respect to FIGS. 5A and 5B).

At block 362, the system causes the responsive content that is responsive to the user input and that reflects the particular interaction style to be rendered at the client device of the user. For example, the system can cause the responsive content to be visually and/or audibly rendered at the client device of the user. For instance, in implementations where the responsive content includes text-based output, the system can cause the text-based output to be visually rendered at a display of the client device of the user. Also, for instance, in implementations where the responsive content includes audio-based output, the system can cause the audio-based output to be audibly rendered via speaker(s) of the client device of the user. In implementations where the given GM is executed locally at the client device of the user, the system can cause the responsive content to be rendered based on the responsive content being generated at the client device of the user. In implementations where the given GM is executed remotely from the client device of the user, the system can cause data to be transmitted to the client device (e.g., over one or more of the networks 199), and the data, when received at the client device, can cause the responsive content to be rendered at the client device of the user.

If, at an iteration of block 356, the system determines that there is not a given GM SFT'ed for the particular interaction style, then the system proceeds to block 364. At block 364, the system processes, using a GM, GM input to generate GM output, the GM input including at least the user input and an indication of the particular interaction style. At block 366, the system determines, based on the GM output, responsive content that is responsive to the user input and that reflects the particular interaction style. At block 368, the system causes the responsive content that is responsive to the user input and that reflects the particular interaction style to be rendered at the client device of the user. The operations of block 364, 366, and 368 can be performed in the same or similar manner as described with respect to the operations of block 358, 360, and 362, respectively. However, in implementations where the system proceeds from block 356 to block 364 (e.g., instead of proceeding to block 358 from block 364), the GM input further includes an indication of the particular interaction style. Put another way, the system can retrieve the particular interaction style from interaction style(s) database 140A (e.g., that was stored in the interaction(s) database 140A) and include an indication of the particular interaction style in the GM input. In some implementations, the indication of the particular interaction style can be, for example, natural language that instructs the GM to utilize a particular type of extension/tool, to ground any responsive content into a specific domain/document/search result, and/or other natural language representations of interaction style(s) described herein, which can then be tokenized. In additional or alternative implementations, the indication of the particular interaction style can be, for example, an embedding (or other lower-level representation) of the interaction style, which can be provided directly to the GM.

Turning now to FIGS. 4A and 4B, various non-limiting examples of conversation activity between a user and a GM based on which interaction style(s) are determined are depicted. FIGS. 4A and 4B each depict a client device 110 (e.g., an instance of the client device 110 from FIG. 1) having a display 181. Although the client device 110 of FIGS. 4A and 4B is depicted as a mobile phone, it should be understood that is not meant to be limiting. The client device 110 can be, for example, a stand-alone assistant device (e.g., with speaker(s) and/or a display), a laptop, a desktop computer, a wearable computing device (e.g., a smart watch, smart headphones, etc.), a vehicular computing device, a game console, and/or any other client device.

The display 181 of the client device 110 in FIGS. 4A and 4B further includes a textual input interface element 184 that the user may select to generate user input via a keyboard (virtual or real) or other touch and/or typed input, and a spoken input interface element 185 that the user may select to generate user input via microphone(s) of the client device 110. In some implementations, the user may generate user input via the microphone(s) without selection of the spoken input interface element 185. For example, active monitoring for audible user input via the microphone(s) may occur to obviate the need for the user to select the spoken input interface element 185. In some of those and/or in other implementations, the spoken input interface element 185 may be omitted. Moreover, in some implementations, the textual input interface element 184 may additionally and/or alternatively be omitted (e.g., the user may only provide audible user input). The display 181 of the client device 110 in FIGS. 4A and 4B also includes system interface elements 181, 182, 183 that may be interacted with by the user to cause the client device 110 to perform one or more actions.

Referring specifically to FIG. 4A, assume that a user of the client device 110 directs user input 452A of “Tell me about [example historical event]” to an application of the client device 110 that provides access to a GM responsive content system (e.g., via the GM responsive content system client 116 or the GM responsive content system 120) as part of a conversation. In response to receiving the user input 452A, further assume that the GM responsive content system generates responsive content 454A1 of “Sure, [example historical event] . . . ”, but does not provide any citations related to [example historical event] as indicated by 454A2. In this example, and since historical events are verifiable through various sources, the user may have expected the GM responsive content system to provide citations related to [example historical event] and include these citations in the responsive content 454A1. Accordingly, the user may provide a follow up user input 456A of “Please re-generate the response and ground it in search results from [example authoritative source]” to force the GM responsive content system to include the desired citations. In response to receiving the follow up user input 456A, further assume that the GM responsive content system generates additional responsive content 458A1 of “Sorry about that, [example historical event] . . . ”, and provides citations related to [example historical event] as indicated by 458A2 and, more specifically, citations to [example authoritative source] as explicitly requested by the user.

Referring specifically to FIG. 4B, assume that a user of the client device 110 directs user input 452B of “Help me plan my trip to California next month, and use a tool for booking flights” to the application of the client device 110 that provides access to the GM responsive content system as part of another conversation. In response to receiving the user input 452B, further assume that the GM responsive content system generates responsive content 454B1 of “Sure, California is a great place to visit this time of year . . . ”, and only includes results from a tool for flights as indicated by 454B2. In this example, and since users typically need to book additional accommodations during travel in addition to just flights, the user may have expected the GM responsive content system to provide output for hotels, rental cars, restaurants, attractions, etc. in the responsive content 454B1. Accordingly, the user may provide a follow up user input 456B of “Please re-generate the response and use tools for booking a hotel and a rental car as well” to force the GM responsive content system to include the desired tool usage. In response to receiving the follow up user input 456B, further assume that the GM responsive content system generates additional responsive content 458B1 of “Sorry about that, California is a great place to visit this time of year . . . ”, and uses the desired tools as indicated by 458B2.

Notably, the conversations in the example of FIGS. 4A and 4B can be conversation activity (e.g., stored in the conversation activity database 130A) that is utilized to determine interaction style(s) of the user of the client device 110 with the GM. For example, and referring back to FIG. 4A, the GM responsive content system can determine a particular interaction style of the user with the GM includes grounding responsive content in particular domain(s)/document(s)/search result(s). For instance, the particular interaction style may be limited to instances where the user input includes a particular type of request, such as the fact seeking request related to [example historical event] in the user input 452A. Also, for instance, the particular interaction style may be limited to instances where the particular domain(s)/document(s)/search result(s) are limited to [example authoritative source] as specified by the follow up user input 456A1. Accordingly, in this example, the particular interaction style determined based on the conversation activity of FIG. 4A can include grounding responsive content in particular domain(s)/document(s)/search result(s), such as citations to [example authoritative source].

Further, and referring back to FIG. 4B, the GM responsive content system can determine a particular interaction style of the user with the GM includes using multiple tools to book accommodations during travel. For instance, the particular interaction style may be limited to instances where the user input includes a particular type of request, such as the trip planning request related to planning the trip to California as specified by the user input 452B. Also, for instance, the particular interaction style may be limited to certain type(s) of tool(s) to be utilized for booking accommodations during travel, such as tools related to booking flights, hotels, and rental cars. Accordingly, in this example, the particular interaction style determined based on the conversation activity of FIG. 4B can include using multiple tools to book accommodations during travel.

The conversation activity from the example of FIGS. 4A and 4B can be processed (e.g., as described with respect to the method 200 of FIG. 2) to determine the interaction style(s) of the user with the GM and/or to SFT GM(s) to ensure that subsequent conversations between the user and the GM will reflect the determined interaction style(s). Notably, as the user continues to interact with the GM responsive content system during additional conversations, new conversation activity can be analyzed and utilized to adapt existing interaction style(s), determine new interaction style(s), and/or in SFT'ing the GM(s). Accordingly, the GM responsive content system can continue to accurately determine the interaction style(s) and adapt over time as the user's needs and/or desires change with respect to their interactions with the GM.

Although the examples of FIGS. 4A and 4B are described with respect to certain conversations and certain interaction style(s), it should be understood that these examples are not meant to be limiting. Rather, and as noted above with respect to the method 200 of FIG. 2, the instructions included in the conversation activity are virtually limitless and, as a result, the interaction style(s) determined based on the conversation activity are also virtually limitless. Nonetheless, by using techniques described herein, the GM responsive content system can continue to adapt to these interaction style(s) over time despite varying input styles of the user.

Turning now to FIGS. 5A and 5B, various non-limiting examples of utilizing interaction style(s) of a user with a GM in generating responsive content are depicted. FIGS. 5A and 5B each depict the same client device 110 (e.g., an instance of the client device 110 from FIG. 1) from FIGS. 4A and 4B. Although the client device 110 of FIGS. 5A and 5B is also depicted as a mobile phone, it should be understood that is not meant to be limiting. The client device 110 can be, for example, a stand-alone assistant device (e.g., with speaker(s) and/or a display), a laptop, a desktop computer, a wearable computing device (e.g., a smart watch, smart headphones, etc.), a vehicular computing device, a game console, and/or any other client device. For the sake of example in FIGS. 5A and 5B, assume that a GM responsive content system (e.g., via the GM responsive content system client 116 or the GM responsive content system 120) that is accessible by the client device 110 has processed the conversation activity of FIGS. 4A and 4B (e.g., as described with respect to the method 200 of FIG. 2).

Referring specifically to FIG. 5A, assume that a user of the client device 110 directs user input 552A of “Tell me about [other example historical event]” to an application of the client device 110 that provides access to the GM responsive content system as part of a conversation. In response to receiving the user input 552A, further assume that the GM responsive content system generates responsive content 554A1 of “Sure, [other example historical event] . . . ”, and provides citations related to [other example historical event] and from [example authoritative source] as indicated by 554A2. In this example, and since the GM responsive content system processed the conversation activity of FIG. 4A, the GM responsive content system has learned a particular interaction style of the user of the client device 110, such as the grounding of responsive content into particular domain(s)/document(s)/search result(s), and optionally using certain source(s). As a result, not only can the responsive content 554A1 be responsive to the user input 552A, but it can also reflect the particular interaction style of the user of the client device 110 with the GM responsive content system. This obviates the need for the user to provide follow up user input to cause the GM responsive content system to include desired citations and/or to ground the responsive content in desired domain(s)/document(s)/search result(s) as in the example of FIG. 4A.

Referring specifically to FIG. 5B, assume that a user of the client device 110 directs user input 552B of “Help me plan my trip to Paris next year” to the application of the client device 110 that provides access to the GM responsive content system as part of another conversation. In response to receiving the user input 552B, further assume that the GM responsive content system generates responsive content 554B1 of “Sure, Paris is . . . ”, and only includes results from a tool for flights, results from a tool for hotels, and results from a tool for rental cars as indicated by 554B2. In this example, and since the GM responsive content system processed the conversation activity of FIG. 4B, the GM responsive content system has learned a particular interaction style of the user of the client device 110, such as using multiple tools to book accommodations during travel, and optionally certain tool(s). As a result, not only can the responsive content 554B1 be responsive to the user input 552B, but it can also reflect the particular interaction style of the user of the client device 110 with the GM responsive content system. This obviates the need for the user to provide follow up user input to cause the GM responsive content system to include desired tool usage as in the example of FIG. 4B.

Although the examples of FIGS. 5A and 5B are described with respect to certain conversations and certain interaction style(s), it should be understood that these examples are not meant to be limiting. Rather, it should be understood that these examples are provided for the sake of illustrating various techniques contemplated herein. Further, although the examples of FIGS. 5A and 5B are not described with respect to using SFT'ed GM(s) and/or utilizing the determined interaction style(s) to supplement user input at inference time, it should be understood that is for the sake of example and is not meant to be limiting. Rather, it should be understood that the same or similar results can be achieved using either implementation since each considers the particular interaction style that is determined based on at least the respective user inputs of FIGS. 5A and 5B.

Turning now to FIG. 6, a block diagram of an example computing device 610 that may optionally be utilized to perform one or more aspects of techniques described herein is depicted. In some implementations, one or more of a client device, cloud-based automated assistant component(s), and/or other component(s) may comprise one or more components of the example computing device 610.

Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 624 may include the logic to perform selected aspects of the methods disclosed herein, as well as to implement various components depicted in FIG. 1.

These software modules are generally executed by processor 614 alone or in combination with other processors. Memory 625 used in the storage subsystem 624 can include a number of memories including a main random access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computing device 610 communicate with each other as intended. Although bus subsystem 612 is shown schematically as a single bus, alternative implementations of the bus subsystem 612 may use multiple busses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by processor(s) is provided and the method includes receiving user input that is associated with a client device of a user; processing, using a generative model (GM) and based on a particular interaction style of the user with the GM that is specific to the user and that is determined based on a plurality of prior interactions between the user and the GM, GM input to generate GM output, the GM input including at least the user input; determining, based on the GM output, responsive content that is responsive to the user input and that reflects the particular interaction style; and causing the responsive content to be rendered at the client device of the user.

These and other implementations of technology disclosed herein can optionally include one or more of the following features.

In some implementations, the particular interaction style can be determined based on one or more of: historical extension/tool usage of the user in requesting prior responsive content, historical robustness of extension/tool usage of the user in requesting prior responsive content, historical grounding of prior responsive content in search results in requesting prior responsive content, an extent of historical grounding of prior responsive content in search results in requesting prior responsive content, historical commenting of code by the user in requesting prior responsive content, or historical robustness of commenting of code by the user in requesting prior responsive content.

In some implementations, the particular interaction style can be characterized by a natural language prompt that is also included in the GM input.

In some implementations, the GM can be an on-device GM of the client device, and the particular interaction style can be utilized to supervise fine-tune the on-device GM.

In some implementations, the method can further include, prior to receiving the user input that is associated with the client device of the user: analyzing conversation activity between the user and the GM; and determining, based on analyzing the conversation activity between the user and the GM, the particular interaction style.

In some versions of those implementations, analyzing the conversation activity between the user and the GM can include identifying instructions included in prior user inputs. Determining the particular interaction style can be based on the instructions included in the prior user inputs.

In additional or alternative versions of those implementations, analyzing the conversation activity between the user and the GM can include identifying instructions included in follow up user inputs that follow prior user inputs. Determining the particular interaction style can be based on the instructions included in the follow up user inputs.

In additional or alternative versions of those implementations, analyzing the conversation activity between the user and the GM can include identifying feedback signals received during one or more conversations that are included in the conversation activity. Determining the particular interaction style can be based on the feedback signals received during one or more of the conversations.

In some of those additional or alternative versions of those implementations, the feedback signals can include one or more of: positive feedback signals with respect to prior responsive content or negative feedback signals with respect to prior responsive content.

In additional or alternative versions of those implementations, analyzing the conversation activity between the user and the GM can be performed locally at the client device of the user.

In some of those additional or alternative versions of those implementations, analyzing the conversation activity can be in response to determining that one or more conditions are satisfied. The one or more conditions can include one or more of: a time of day, a day of week, whether the client device is being held by the user, or whether the client device has a threshold state of charge.

In some implementations, the method can further include, in response to receiving the user input that is associated with the client device of the user, selecting, from among a plurality of interaction styles that are specific to the user, the particular interaction style that is specific to the user.

In some versions of those implementations, the particular interaction style can be selected based on a type of a request included in the user input.

In additional or alternative versions of those implementations, the type of the request included in the user input can be one of: a code generation request, a search result generation request, a text generation request, a text summarization request, an image generation request, or a video generation request.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform any of the aforementioned methods. Some implementations also include a computer program product including instructions executable by one or more processors to perform any of the steps of the aforementioned systems. Some implementations also include a method implemented by one or more processors to perform any of the steps of the aforementioned systems.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

What is claimed is:

1. A method implemented by one or more processors, the method comprising:
receiving user input that is associated with a client device of a user;
processing, using a generative model (GM) and based on a particular interaction style of the user with the GM that is specific to the user and that is determined based on a plurality of prior interactions between the user and the GM, GM input to generate GM output, the GM input including at least the user input;
determining, based on the GM output, responsive content that is responsive to the user input and that reflects the particular interaction style; and
causing the responsive content to be rendered at the client device of the user.

2. The method of claim 1, wherein the particular interaction style is determined based on one or more of: historical extension/tool usage of the user in requesting prior responsive content, historical robustness of extension/tool usage of the user in requesting prior responsive content, historical grounding of prior responsive content in search results in requesting prior responsive content, an extent of historical grounding of prior responsive content in search results in requesting prior responsive content, historical commenting of code by the user in requesting prior responsive content, or historical robustness of commenting of code by the user in requesting prior responsive content.

3. The method of claim 1, wherein the particular interaction style is characterized by a natural language prompt that is also included in the GM input.

4. The method of claim 1, wherein the GM is an on-device GM of the client device, and wherein the particular interaction style is utilized to supervise fine-tune the on-device GM.

5. The method of claim 1, further comprising:
prior to receiving the user input that is associated with the client device of the user:
analyzing conversation activity between the user and the GM; and
determining, based on analyzing the conversation activity between the user and the GM, the particular interaction style.

6. The method of claim 5, wherein analyzing the conversation activity between the user and the GM comprises:
identifying instructions included in prior user inputs, wherein determining the particular interaction style is based on the instructions included in the prior user inputs.

7. The method of claim 5, wherein analyzing the conversation activity between the user and the GM comprises:
identifying instructions included in follow up user inputs that follow prior user inputs, wherein determining the particular interaction style is based on the instructions included in the follow up user inputs.

8. The method of claim 5, wherein analyzing the conversation activity between the user and the GM comprises:
identifying feedback signals received during one or more conversations that are included in the conversation activity, wherein determining the particular interaction style is based on the feedback signals received during one or more of the conversations.

9. The method of claim 8, wherein the feedback signals include one or more of: positive feedback signals with respect to prior responsive content or negative feedback signals with respect to prior responsive content.

10. The method of claim 5, wherein analyzing the conversation activity between the user and the GM is performed locally at the client device of the user.

11. The method of claim 10, wherein analyzing the conversation activity is in response to determining that one or more conditions are satisfied, wherein the one or more conditions comprise one or more of: a time of day, a day of week, whether the client device is being held by the user, or whether the client device has a threshold state of charge.

12. The method of claim 1, further comprising:
in response to receiving the user input that is associated with the client device of the user:
selecting, from among a plurality of interaction styles that are specific to the user, the particular interaction style that is specific to the user, wherein the GM input further includes an indication of the particular interaction style that is specific to the user.

13. The method of claim 12, wherein the particular interaction style is selected based on a type of a request included in the user input.

14. The method of claim 12, wherein the type of the request included in the user input is one of: a code generation request, a search result generation request, a text generation request, a text summarization request, an image generation request, or a video generation request.

15. A system comprising:
at least one processor; and
memory storing instructions that, when executed, cause the at least one processor to be operable to:
receive user input that is associated with a client device of a user;
process, using a generative model (GM) and based on a particular interaction style of the user with the GM that is specific to the user and that is determined based on a plurality of prior interactions between the user and the GM, GM input to generate GM output, the GM input including at least the user input;
determine, based on the GM output, responsive content that is responsive to the user input and that reflects the particular interaction style; and
cause the responsive content to be rendered at the client device of the user.

16. The system of claim 15, wherein the particular interaction style is determined based on one or more of: historical extension/tool usage of the user in requesting prior responsive content, historical robustness of extension/tool usage of the user in requesting prior responsive content, historical grounding of prior responsive content in search results in requesting prior responsive content, an extent of historical grounding of prior responsive content in search results in requesting prior responsive content, historical commenting of code by the user in requesting prior responsive content, or historical robustness of commenting of code by the user in requesting prior responsive content.

17. The system of claim 15, wherein the particular interaction style is characterized by a natural language prompt that is also included in the GM input.

18. The system of claim 15, wherein the GM is an on-device GM of the client device, and wherein the particular interaction style is utilized to supervise fine-tune the on-device GM.

19. The system of claim 15, wherein the at least one processor is further operable to:
prior to receiving the user input that is associated with the client device of the user:
analyze conversation activity between the user and the GM; and
determine, based on analyzing the conversation activity between the user and the GM, the particular interaction style, wherein the instructions to determine the particular interaction style based on analyzing the conversation activity between the user and the GM comprise instructions to:
identify instructions included in prior user inputs, wherein determining the particular interaction style is based on the instructions included in the prior user inputs;
identify instructions included in follow up user inputs that follow prior user inputs, wherein determining the particular interaction style is based on the instructions included in the follow up user inputs; and/or
identify feedback signals received during one or more conversations that are included in the conversation activity, wherein determining the particular interaction style is based on the feedback signals received during one or more of the conversations.

20. A non-transitory computer-readable storage medium storing computer-readable instructions that, when executed by at least one processor, cause the at least processor to execute the computer-readable instructions to:
receive user input that is associated with a client device of a user;
process, using a generative model (GM) and based on a particular interaction style of the user with the GM that is specific to the user and that is determined based on a plurality of prior interactions between the user and the GM, GM input to generate GM output, the GM input including at least the user input;
determine, based on the GM output, responsive content that is responsive to the user input and that reflects the particular interaction style; and
cause the responsive content to be rendered at the client device of the user.
